(19) United States
(12) Patent Application Publication
(10) Pub. No.: US 2009/0224584 A1
(43) Pub. Date: Sep. 10, 2009

(54) ACTIVE MATERIAL ACTUATED SEAT BASE EXTENDER

(75) Inventors: Jennifer P. Lawall, Waterford, MI (US); Diane K. McQueen, Leonard, MI (US); Steven E. Morris, Fair Haven, MI (US); Nancy L. Johnson, Northville, MI (US); Paul W. Alexander, Ypsilanti, MI (US); Alan L. Browne, Grosse Pointe, MI (US); Gary L. Jones, Farmington Hills, MI (US); Nillesh D. Mankame, Ann Arbor, MI (US)

Correspondence Address: SLJ, LLC, 324 E. 11th St., Ste. 101, Kansas City, MO, 64106, US

(73) Assignee: GM GLOBAL TECHNOLOGY OPERATIONS, INC., Detroit, MI (US)

(21) Appl. No.: 12/392,080

(22) Filed: Feb. 24, 2009

Related U.S. Application Data
(60) Provisional application No. 61/033,650, filed on Mar. 4, 2008.

(51) Int. Cl. B60N 2/02

(52) U.S. Cl. 297/311

(57) ABSTRACT

A seat base extension system adapted for use with a seat defining a support length, and including an active-material based actuator configured to cause or enable the support length to be extended and retracted.

### RELATED APPLICATIONS

This patent application makes reference to, claims priority to, and claims benefit from U.S. Provisional Patent Application Ser. No. 61/033,650, entitled “ACTIVE MATERIAL ACTUATED SEAT BASE EXTENDER,” filed on Mar. 4, 2008.

### BACKGROUND OF THE INVENTION

1. Field of the Invention

The present disclosure generally relates to seat bases, and more particularly, to a seat cushion or base extender having an active material actuator drivenly coupled to and operable to extend or retract the distal edge of the base.

2. Discussion of Prior Art

Conventional seat bases or cushions are configured to support the posterior of an occupant. Concernedly, however, these bases commonly present a constant length regardless of occupant size or preference. That is to say, although the seat as a whole is typically manipulable, the support length is usually static. Of further concern in an automotive setting, rear passenger seat bases typically present fixed positioning that hinders the ability of the occupant to enter and exit the vehicle. As a result, powered and non-powered cushion extensions have been developed in the art; however, embodiments have garnered limited application and use due to complex electro-mechanical actuation or locking.

### BRIEF SUMMARY OF THE INVENTION

The present invention addresses these concerns by providing a seat base extension system that uses active material actuation to effect extending/retracting the support length, or releasing a locking mechanism so as to allow the same. The invention is therefore useful for presenting an energy efficient seat extension/retraction solution that better accommodates a plurality of differing (e.g., in size and/or preference) occupants. That is to say, by being extendable, the seat base is better able to support the thighs of larger occupants; whereas conventional seat bases are typically tailored to fit an average size adult occupant. Utility of invention is further provided in that smaller vehicles are able to facilitate entry and egress by on-demand shortening of the length of the seat bases. Finally, it is appreciated that the use of active material actuation (in lieu of electromechanical motors, solenoids, etc.) results in reduced weight, packaging requirements, and noise (both acoustically and with respect to EMF).

In general, the inventive system includes a reconfigurable seat base presenting a first support length, an actuator drivenly coupled to the base and including an active material element, and a signal source operable to generate and deliver the signal to the element, so as to activate the signal. The actuator is configured to cause or enable the base to reconfigure, so as to present a second support length different than the first, when activated.

This disclosure may be understood more readily by reference to the following detailed description of the various features of the disclosure and the examples included therein.

### BRIEF DESCRIPTION OF THE SEVERAL VIEWS OF THE DRAWING

A preferred embodiment(s) of the invention is described in detail below with reference to the attached drawing figures of exemplary scale, wherein:

FIG. 1 is a perspective view of an automotive seat having a base and an upright, particularly illustrating a base extension system including a pivotal structure communicatively coupled to a controller, signal source, input device, and sensor, in accordance with a preferred embodiment of the invention;

FIG. 2 is a side elevation of an automotive seat base, showing internally a base extension system including a shape memory wire actuator, pivotal structure, and in enlarged caption view a toothed gear locking mechanism, in accordance with a preferred embodiment of the invention;

FIG. 3 is a partial elevation of a base extension system including a fixed section, manually adjustable free section, stored energy element and in enlarged caption view a toothed bar locking mechanism, in accordance with a preferred embodiment of the invention;

FIG. 4 is a top view of the system shown in FIG. 3, further including a bow-string shape memory wire actuator, and in enlarged caption view, an overload protector, in accordance with a preferred embodiment of the invention;

FIG. 5 is a partial side elevation of a base extension system including a manually adjustable free section selectively engaged by a toothed bar and pin locking mechanism, and a stored energy element, in accordance with a preferred embodiment of the invention;

FIG. 6 is a top view of the system shown in FIG. 5 further illustrating a shape memory wire actuator intercoupling the pins, and a button input device communicatively coupled to the actuator, in accordance with a preferred embodiment of the invention;

FIG. 7 is a side elevation of a rack and pinion adapted for use with the system shown in FIGS. 5 and 6, in accordance with a preferred embodiment of the invention;

FIG. 8 is a partial perspective view of a notched bar and square pin adapted for locking a base extension system, so as to bi-directionally prevent motion, in accordance with a preferred embodiment of the invention;

FIG. 9a is a perspective view of a layer having a faceted distal segment comprised of plural pads, and first and second shape memory wires drivenly coupled to the segment, in accordance with a preferred embodiment of the invention;

FIG. 9b is a perspective view of the layer shown in FIG. 9a, wherein the wires have been activated, so as to straighten and extend the segment, in accordance with a preferred embodiment of the invention;

FIG. 10a is a side elevation of a layer having a flexible distal segment defining an interior space, a distal coupling disposed within the space, and a sliding mechanism interconnected to the coupling by at least one shape memory wire also within the space, in accordance with a preferred embodiment of the invention;

FIG. 10b is a side elevation of the layer shown in FIG. 10a wherein the wire has been activated, such that the slider is caused to outwardly translate, and the base to extend accordingly;

FIG. 11 is a side elevation of a base extension system including a four-bar linkage assembly, a shape memory wire actuator entrained by a pulley and drivenly coupled to the assembly, and an internal return mechanism, in accordance with a preferred embodiment of the invention;

FIG. 12 is a side elevation of a flexible structural member pivotally connected to the base frame and presenting a first raised position (in solid-line type) and an extended position cooperatively caused by the activation of a shape memory wire actuator and the weight of the occupant (in hidden-line type), in accordance with a preferred embodiment of the invention; and

FIG. 13 is a side elevation of the member shown in FIG. 12 wherein the vertical component defines a hinge and the wire moved to straddle the hinge, in accordance with a preferred embodiment of the invention.

### DETAILED DESCRIPTION OF THE INVENTION

The following description of the preferred embodiments of an active-material actuated seat base extension system 10 is merely exemplary in nature and is in no way intended to limit the invention, its application, or uses. The invention is described and illustrated with respect to an automotive seat 12 including a base or cushion 12a configured to support the posterior of an occupant (not shown); it is well appreciated, however, that the benefits of the present invention may be utilized variously with other types of seats (or furniture), including, for example, reclining sofas, airplane seats, and child seats. In the illustrated embodiment, the seat 12 is of the type further having an upright (or seatback) 12b.

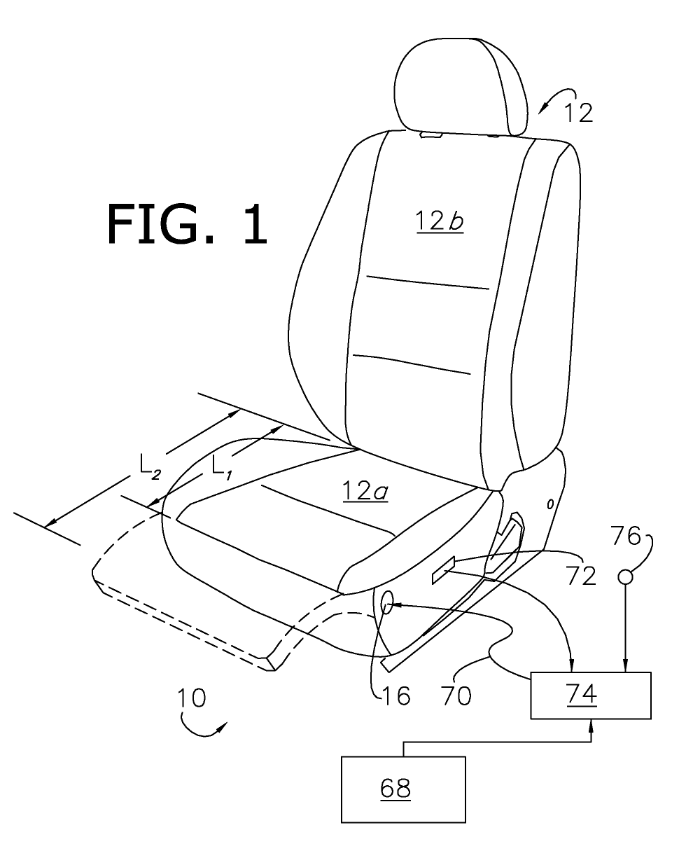

FIG. 1 shows a seat base 12a in a normal state, wherein a first support length, L₁, is defined. In a first aspect of the invention, at least a portion of the base 12a is drivenly coupled to or otherwise associated with at least one active material element 14, so as to be reconfigurable thereby. Here, reconfiguration causes the support length to extend or retract to a second length, L₂. In a second aspect, activation of the element 14 enables reconfiguration otherwise (e.g., manually) actuated. That is to say, the active material element 14 is used to drive or enable the displacement or reconfiguration of at least a portion of the base 12a, so as to modify the support length.

I. Active Material Description and Functionality

As used herein the term “active material” shall be afforded its ordinary meaning as understood by those of ordinary skill in the art, and includes any material or composite that exhibits a reversible change in a fundamental (e.g., chemical or intrinsic physical) property, when exposed to an external signal source. Thus, active materials shall include those compositions that can exhibit a change in stiffness properties, shape and/or dimensions in response to an activation signal.

Active materials include, without limitation, shape memory alloys (SMA), ferromagnetic shape memory alloys, electroactive polymers (EAP), piezoelectric materials, magnetorheological elastomers, electrorheological elastomers, high-output-paraffin (HOP) wax actuators, and the like. Depending on the particular active material, the activation signal can take the form of, without limitation, heat energy, an electric current, an electric field (voltage), a temperature change, a magnetic field, a mechanical loading or stressing, and the like, with the particular activation signal dependent on the materials and/or configuration of the active material. For example, a magnetic field may be applied for changing the property of the active material fabricated from magnetostrictive materials. A heat signal may be applied for changing the property of thermally activated active materials such as SMA. An electrical signal may be applied for changing the property of the active material fabricated from electroactive materials and piezoelectrics (PZT's).

Suitable active materials for use with the present invention include but are not limited to shape memory alloys, ferromagnetic shape memory alloys, electroactive polymers (EAP), piezoelectric ceramics, and other active materials that function as actuators. These types of active materials have the ability to remember their original shape and/or elastic modulus, which can subsequently be recalled by applying an external stimulus. As such, deformation from the original shape is a temporary condition. In this manner, an element composed of these materials can change to the trained shape in response to an activation signal.

More particularly, shape memory alloys (SMA's) generally refer to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. The term “yield strength” refers to the stress at which a material exhibits a specified deviation from proportionality of stress and strain. Generally, in the low temperature, or martensite phase, shape memory alloys can be pseudo-plastically deformed and upon exposure to some higher temperature will transform to an austenite phase, or parent phase, returning to their shape prior to the deformation.

Thus, shape memory alloys exist in several different temperature-dependent phases. The most commonly utilized of these phases are the so-called martensite and austenite phases discussed above. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (Aₛ). The temperature at which this phenomenon is complete is called the austenite finish temperature (A_{f}).

When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). Generally, the shape memory alloys are softer and more easily deformable in their martensitic phase and are harder, stiffer, and/or more rigid in the austenitic phase. In view of the foregoing, a suitable activation signal for use with shape memory alloys is a thermal activation signal having a magnitude to cause transformations between the martensite and austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the martensite to austenite type transition, and the material will recover the original, annealed shape. Hence, one-way shape memory effects are only observed upon heating. Active materials comprising shape memory alloy compositions that exhibit one-way memory effects do not automatically reform, and will likely require an external mechanical force to reform the shape that was previously presented.

Intrinsic and extrinsic two-way shape memory materials are characterized by a shape transition both upon heating from the martensite phase to the austenite phase, as well as an additional shape transition upon cooling from the austenite phase back to the martensite phase. Active materials that exhibit an intrinsic shape memory effect are fabricated from a shape memory alloy composition that will cause the active materials to automatically reform themselves as a result of the above noted phase transformations.

Intrinsic two-way shape memory behavior must be induced in the shape memory material through processing. Such procedures include extreme deformation of the material while in the martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effects are composite or multi-component materials that combine a shape memory alloy composition that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the system with shape memory effects, super-elastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

It is appreciated that SMA's exhibit a modulus increase of 2.5 times and a dimensional change of up to 8% (depending on the amount of pre-strain) when heated above their Martensite to Austenite phase transition temperature. It is appreciated that thermally induced SMA phase changes are one-way so that a biasing force return mechanism (such as a spring) would be required to return the SMA to its starting configuration once the applied field is removed. Joule heating can be used to make the entire system electronically controllable.

Stress induced phase changes in SMA, caused by loading and unloading, are, however, two way by nature. That is to say, application of sufficient stress when an SMA is in its austenitic phase will cause it to change to its lower modulus martensitic phase in which it can exhibit up to 8% of “superelastic” deformation. Removal of the applied stress will cause the SMA to button back to its austenitic phase in so doing recovering its starting shape and higher modulus.

Ferromagnetic Shape Memory Alloys (FSMA) are a sub-class of SMA. FSMA can behave like conventional SMA materials that have a stress or thermally induced phase transformation between martensite and austenite. Additionally FSMA are ferromagnetic and have strong magneto-crystalline anisotropy, which permit an external magnetic field to influence the orientation/ fraction of field aligned martensitic variants. When the magnetic field is removed, the material exhibits partial two-way or one-way shape memory. For partial or one-way shape memory, an external stimulus, temperature, magnetic field or stress may permit the material to return to its starting state. Perfect two-way shape memory may be used for proportional control with continuous power supplied. One-way shape memory is most useful for latching-type applications where a delayed return stimulus permits a latching function. External magnetic fields are generally produced via soft-magnetic core electromagnets in automotive applications. Electric current running through the coil induces a magnetic field through the FSMA material, causing a change in shape. Alternatively, a pair of Helmholtz coils may also be used for fast response.

Exemplary ferromagnetic shape memory alloys are nickel-manganese-gallium based alloys, iron-platinum based alloys, iron-palladium based alloys, cobalt-nickel-aluminum based alloys, cobalt-nickel-gallium based alloys. Like SMA these alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range and the type of response in the intended application.

Electroactive polymers include those polymeric materials that exhibit piezoelectric, pyroelectric, or electrostrictive properties in response to electrical or mechanical fields. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems. These may be operated as a piezoelectric sensor or even an electrostrictive actuator.

Materials suitable for use as an electroactive polymer may include any substantially insulating polymer or rubber (or combination thereof) that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties, and the like. Polymers comprising silicone and acrylic moieties may include copolymers comprising silicone and acrylic moieties, polymer blends comprising a silicone elastomer and an acrylic elastomer, for example.

Materials used as an electroactive polymer may be selected based on one or more material properties such as a high electrical breakdown strength, a low modulus of elasticity—(for large or small deformations), a high dielectric constant, and the like. In one embodiment, the polymer is selected such that it has a maximum elastic modulus of about 100 MPa. In another embodiment, the polymer is selected such that it has a maximum actuation pressure between about 0.05 MPa and about 10 MPa, and preferably between about 0.3 MPa and about 3 MPa. In another embodiment, the polymer is selected such that is has a dielectric constant between about 2 and about 20, and preferably between about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers may be fabricated and implemented as thin films. Thickness suitable for these thin films may be below 50 micrometers.

As electroactive polymers may deflect at high strains, electrodes attached to the polymers should also deflect without compromising mechanical or electrical performance. Generally, electrodes suitable for use may be of any shape and material provided that they are able to supply a suitable voltage to, or receive a suitable voltage from, an electroactive polymer. The voltage may be either constant or varying over time. In one embodiment, the electrodes adhere to a surface of the polymer. Electrodes adhering to the polymer are preferably compliant and conform to the changing shape of the polymer. Correspondingly, the present disclosure may include compliant electrodes that conform to the shape of an electroactive polymer to which they are attached. The electrodes may be only applied to a portion of an electroactive polymer and define an active area according to their geometry. Various types of electrodes suitable for use with the present disclosure include structured electrodes comprising metal traces and charge distribution layers, textured electrodes comprising varying out of plane dimensions, conductive greases such as carbon greases or silver greases, colloidal suspensions, high aspect ratio conductive materials such as carbon fibrils and carbon nanotubes, and mixtures of ionically conductive materials.

Materials used for electrodes of the present disclosure may vary. Suitable materials used in an electrode may include graphite, carbon black, colloidal suspensions, thin metals including silver and gold, silver filled and carbon filled gels and polymers, and ionically or electronically conductive polymers. It is understood that certain electrode materials may work well with particular polymers and may not work as well for others. By way of example, carbon fibrils work well with acrylic elastomer polymers while not as well with silicone polymers.

Suitable piezoelectric materials include, but are not intended to be limited to, inorganic compounds, organic compounds, and metals. With regard to organic materials, all of the polymeric materials with non-centrosymmetric structure and large dipole moment group(s) on the main chain or on the side-chain, or on both chains within the molecules, can be used as suitable candidates for the piezoelectric film. Exemplary polymers include, for example, but are not limited to, poly(sodium 4-styrenesulfonate), poly (poly(vinylamine) backbone azo chromophore), and their derivatives; polyfluorocarbons, including polyvinylidenefluoride, its co-polymer vinylidene fluoride (“VDF”), co-trifluoroethylene, and their derivatives; polychlorocarbons, including poly(vinyl chloride), polyvinylidene chloride, and their derivatives; polyacrylonitriles, and their derivatives; polycarboxylic acids, including poly(methacrylic acid), and their derivatives; polyureas, and their derivatives; polyurethanes, and their derivatives; bio-molecules such as poly-L-lactic acids and their derivatives, and cell membrane proteins, as well as phosphate bio-molecules such as phosphodilipids; polyanilines and their derivatives, and all of the derivatives of tetramines; polyamides including aromatic polyamides and polyimides, including Kapton and polyetherimide, and their derivatives; all of the membrane polymers; poly(N-vinyl pyrrolidone) (PVP) homopolymer, and its derivatives, and random PVP-co-vinyl acetate copolymers; and all of the aromatic polymers with dipole moment groups in the main-chain or side-chains, or in both the main-chain and the side-chains, and mixtures thereof.

Piezoelectric material can also comprise metals selected from the group consisting of lead, antimony, manganese, tantalum, zirconium, niobium, lanthanum, platinum, palladium, nickel, tungsten, aluminum, strontium, titanium, barium, calcium, chromium, silver, iron, silicon, copper, alloys comprising at least one of the foregoing metals, and oxides comprising at least one of the foregoing metals.. Suitable metal oxides include SiO₂, Al₂O₃, ZrO₂, TiO₂, SrTiO₃, PbTiO₃, BaTiO₃, FeO₃, Fe₃O₄, ZnO, and mixtures thereof and Group VIA and JIB compounds, such as CdSe, CdS, GaAs, AgCaSe₂, ZnSe, GaP, InP, ZnS, and mixtures thereof. Preferably, the piezoelectric material is selected from the group consisting of polyvinylidene fluoride, lead zirconate titanate, and barium titanate, and mixtures thereof.

Finally, it is appreciated that piezoelectric ceramics can also be employed to produce force or deformation when an electrical charge is applied. PZT ceramics consists of ferroelectric and quartz material that are cut, ground, polished, and otherwise shaped to the desired configuration and tolerance. Ferroelectric materials include barium titanate, bismuth titanate, lead magnesium niobate, lead metaniobate, lead nickel niobate, lead zinc titanates (PZT), lead-lanthanum zirconate titanate (PLZT) and niobium-lead zirconate titanate (PNZT). Electrodes are applied by sputtering or screen printing processes, and then the block is put through a poling process where it takes on macroscopic piezoelectric properties. Multi-layer piezo-actuators typically require a foil casting process that allows layer thickness down to 20 μm. Here, the electrodes are screen printed and the sheets laminated; a compacting process increases the density of the green ceramics and removes air trapped between the layers. Final steps include a binder burnout, sintering (co-firing) at temperatures below 1100° C., wire lead termination, and poling.

Barium titanates and bismuth titanates are common types of piezoelectric ceramics Modified barium-titanate compositions combine high-voltage sensitivity with temperatures in the range of −10° C. to 60° C. Barium titanate piezoelectric ceramics are useful for hydrophones and other receiving devices. These piezoelectric ceramics are also used in low-power projectors. Bismuth titanates are used in high temperature applications, such as pressure sensors and accelerometers. Bismuth titanate belongs to the group of sillenite structure-based ceramics (Bi₁₂MO₂O where M=Si, Ge, Ti).

Lead magnesium niobates, lead metaniobate, and lead nickel niobate materials are used in some piezoelectric ceramics. Lead magnesium niobate exhibits an electrostrictive or relaxor behavior where strain varies non-linearly. These piezoelectric ceramics are used in hydrophones, actuators, receivers, projectors, sonar transducers, and in micro-positioning devices because they exhibit properties not usually present in other types of piezoelectric ceramics. Lead magnesium niobate also has negligible aging, a wide range of operating temperatures and a low dielectric constant. Like lead magnesium niobate, lead nickel niobate may exhibit electrostrictive or relaxor behaviors where strain varies non-linearly.

Piezoelectric ceramics include PZN, PLZT, and PNZT. PZN ceramic materials are zinc-modified, lead niobate compositions that exhibit electrostrictive or relaxor behavior when non-linear strain occurs. The relaxor piezoelectric ceramic materials exhibit a high-dielectric constant over a range of temperatures during the transition from the ferroelectric phase to the paraelectric phase. PLZT piezoelectric ceramics were developed for moderate power applications, but can also be used in ultrasonic applications. PLZT materials are formed by adding lanthanum ions to a PZT composition. PNZT ceramic materials are formed by adding niobium ions to a PZT composition. PNZT ceramic materials are applied in high-sensitivity applications such as hydrophones, sounders and loudspeakers.

Piezoelectric ceramics include quartz, which is available in mined-mineral form and man-made fused quartz forms. Fused quartz is a high-purity, crystalline form of silica used in specialized applications such as semiconductor wafer boats, furnace tubes, bell jars or quartzware, silicon melt crucibles, high-performance materials, and high-temperature products. Piezoelectric ceramics such as single-crystal quartz are also available.

II. Exemplary Base Extension Configurations, Applications, and Use

Returning to FIGS. 1-13, there are shown various embodiments of an active material base extension system 10. In each embodiment, the base 12a will be caused or enabled to be extended (lengthened) and/or retracted (shortened) to obtain varying support lengths by an active material motion actuator 16.

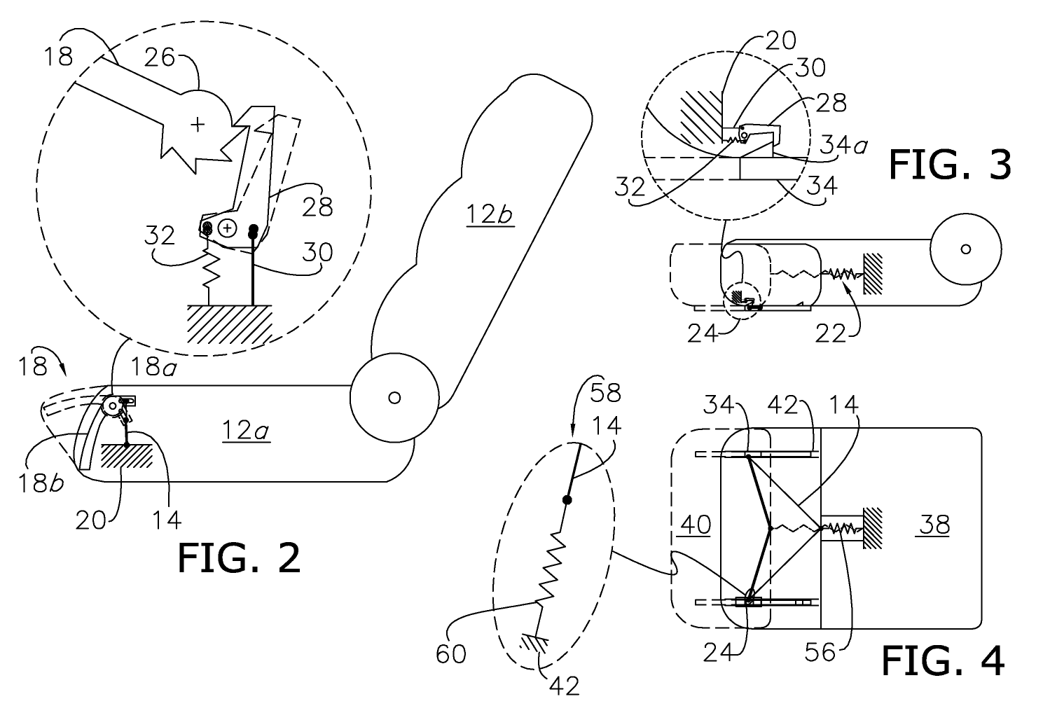

As previously mentioned, the first aspect of the invention provides direct actuation. In FIGS. 1 and 2, for example, the base 12a includes a moveable structure 18 that is pivotally connected to the base frame 20, so as to define a pivot axis. The actuator 16 consists essentially of an SMA wire 14 interconnecting the structure 18 and frame 20. The structure 18 presents an angled flap co-extending with the base 12a and defining short and extending panels 18a,b (FIG. 2). As illustrated, the actuator 16 is configured to pull down the short panel 18a, such that the extending side 18b is caused to swing outward and establishes the second length. Alternatively, the structure 18 may be caused to pivot from the raised position to the lowered position, or vice versa.

It is appreciated that the wire 14 is of suitable gauge and composition to effect the intended function. The wire 14 is preferably connected to the frame 20 at its ends, and medially coupled to the structure 18, so as to form a vertex therewith, and a bow-string configuration (FIG. 4). In this configuration, it is appreciated that wire activation results in amplified displacement at the vertex due to the trigonometric relationship presented.

As used herein, the term “wire” is non-limiting, and encompasses other equivalent geometric configurations such as bundles, loops, braids, cables, ropes, chains, strips, etc. For example, the wire 14 may present a looped configuration, wherein actuation force is doubled but displacement is halved. The wire 14 may be oriented as illustrated, or redirected by wrapping it around one or more pulleys, bent structures, etc., to facilitate packaging. The wire 14 is preferably connected to the structure 18 and frame 20 through reinforcing structural fasteners (e.g., crimps, etc.), which facilitate and isolate mechanical and electrical connection. Finally, for tailored force and displacement performance, the actuator 16 may include a plurality of active material elements 14 (e.g., SMA wires) configured electrically or mechanically in series or parallel, and mechanically connected in telescoping, stacked, or staggered configurations. The electrical configuration may be modified during operation by software timing, circuitry timing, and external or actuation induced electrical contact.

As shown in FIGS. 3, 5 and 6, the motion actuator 16 may function to retract the support length, and include a stored energy element 22 intermediately coupled to the structure 18 and base frame 20. Here, where the occupant manually causes extension, the stored energy element 22 is caused to store energy. For example, in the illustrated embodiment the element 22 is an extension spring. The active element 14, in this configuration, functions to release the stored energy, so that the element 22 causes the structure 18 to retract, or with respect to FIGS. 1 and 2, to swing back towards the lowered position.

As such, whether as a release to stored energy or a zero-power hold in the actuated extension configurations, the preferred system 10 further includes a locking mechanism (or “latch”) 24 (FIG. 3) that engages the structure 18, so as to prevent reconfiguration.

In FIG. 2, the locking mechanism 24 includes a “toothed” gear 26 fixedly coupled to the structure 18, so as to be concentrically aligned with the axis. A pawl 28 pivotally connected to the frame 20 is operable to selectively engage the gear 26, so as to prevent relative motion between the structure 18 and frame 20 in one direction. A second active material element (e.g., SMA wire) 30 is connected to the pawl 28 and configured to cause the pawl 28 to selectively disengage the structure 18, so as to enable its return (FIG. 2). Finally, a return mechanism (e.g., an extension, compression, torsional spring, or a third active material element, etc.) 32 functions antagonistically to the disengaging element 30, so as to bias the mechanism 24 towards the engaged position. It is preferable to construct the locking mechanism 24 so as to provide a passive overload protector; for example, wherein the pawl 28 and/or frame 20 present a break-away connection point(s) or link.

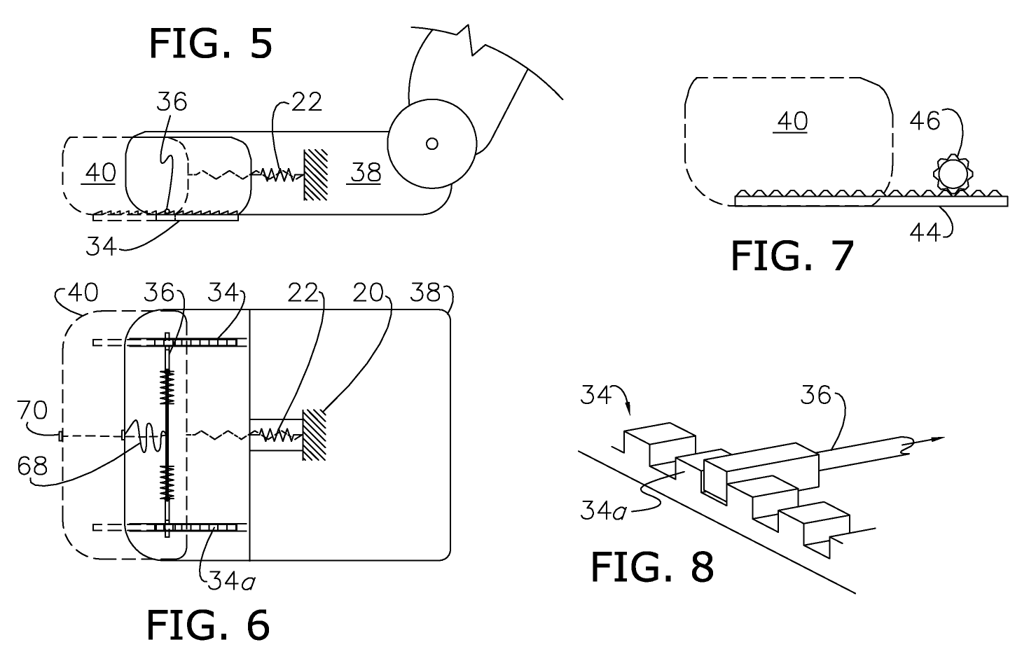

As shown in FIG. 3, the latch 24 may be used to interlock a toothed bar 34 instead of the gear 26. Alternatively, and as shown in FIGS. 5, 6 and 8, the toothed bar 34 may be utilized in conjunction with at least one moveable pin 36 to lock the base 12a at the desire length. In one example, the bar(s) 34 may be fixedly connected to the moveable structure 18 and present a plurality of teeth or notches 34a, each configured to catch the pin 36 in the engaged condition. In FIG. 6, first and second opposite pins 36a,b are interconnected by an SMA wire 14, such that activation of the wire 14 causes the pins 36a,b to draw inward until they clear the teeth or notches 34a. The pins 36a,b are preferably spring biased towards the engaged condition. Where sloped teeth 34a are defined, and the pin 36 is further biased normally towards the bar 34, so that motion is enabled in only one direction by sliding along the sloped sides (FIG. 5). It is appreciated that motion may be bi-directionally prevented, where the bar notches 34a and cross-section of the pin 36 are rectangular in shape (FIG. 8). In the disengaged condition, the occupant is able to manually reconfigure the base 12a to the desired length.

The base 12a may present first and second longitudinally separated sections 38,40 that cooperatively present the first length, when adjacently positioned (FIGS. 3-7). Here, the occupant is able to pull the second section outward, when the latch 24 is in the disengaged condition (or at all times, where sloped teethed are presented). In the illustrated embodiments, the first section 38 is defined by the remainder of the base 12a and is fixed, while the second section 40 is laterally congruent to the first section 38 and free to translate. Parallel tracks 42 are preferably provided to guide translation, and together the first and second sections 38,40 form mated pairs.

In this configuration, the actuator 16 is configured to horizontally translate the free section 40 to a second position that extends the support length. Again, the actuator 16 may consist of an SMA wire 14 linearly interconnecting the section 40 and base frame 20. More preferably, the wire 14 presents a bow-string configuration as previously described (FIG. 4). An outer cushion layer preferably overlays the sections 38,40 in both the first and second lengths, so as to present a continuous occupant engagement surface.

Alternatively, and as shown in FIG. 7, the sections 38,40 may be coupled through a rack 44 and pinion 46. The actuator 16 is drivenly coupled to either the rack 44 or pinion 46, such that activation of the element 14 causes relative displacement therebetween. For example, the actuator 16 may consist of a spooled SMA wire 14 or torque tube (not shown) that engages the pinion axle, such that activation of the actuator 16 causes the pinion 46 to rotate, and therefore the rack 44 and free section 40 to translate. It is appreciated that an alternative transmission such as a mechanical linkage, nut and screw drive, a gear drive, or a hydraulic or pneumatic coupling may be used in place of the rack 44 and pinion 46.

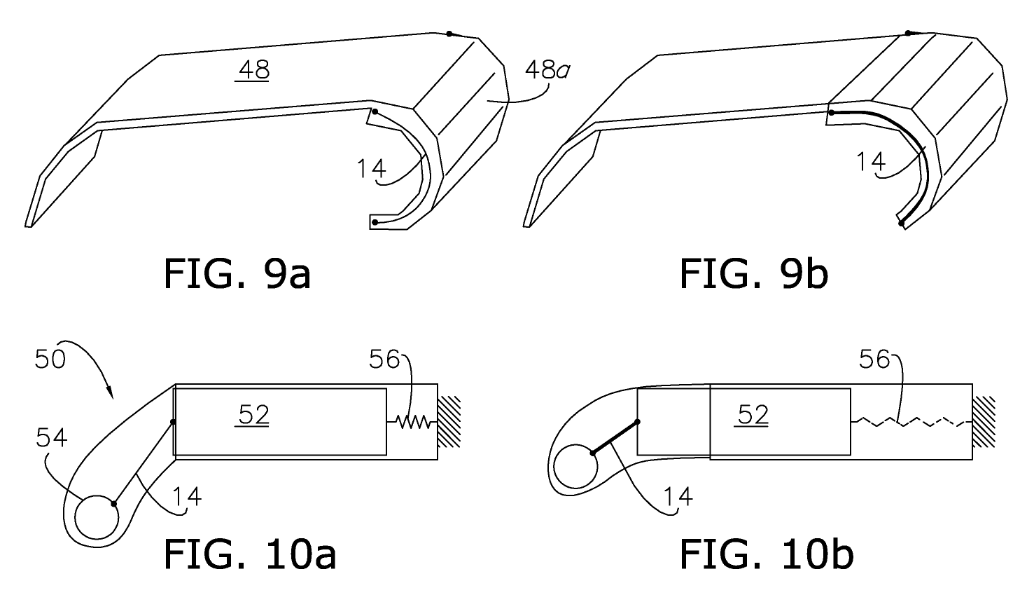

In another example, the base 12a includes a faceted distal segment 48. The segment 48 is pliable (FIGS. 9a,b), so as to present a normally distended configuration that overlays the base frame 20 and cushion layer, and defines the first length. More particularly, the segment 48 consists of a plurality of pads 48a that are adjacently interconnected at their lower corners. This allows the segment 48 to bend downward (or clockwise) only. In this configuration, the actuator 16 may consist of first and second SMA wires 14 interconnecting the pads 48a preferably along their lateral extremities, as shown. The wires 14 are configured to cause the segment 48 to achieve the second support length, when activated. It is appreciated that the shape memory of the wires 14 causes the segment 48 to straighten, as opposed to further curl, upon activation.

In yet another embodiment shown in FIGS. 10a,b, the base 12a includes a flexible distal segment 50 defining an internal space. For example, the flexible segment 50 may comprise cantilevered protective outer and cushion layers having no structural support. The actuator 16 includes a sliding structure (or “slider”) 52 and a coupling 54 secured distally within the space. The slider 52 and coupling 54 are interconnected by at least one active material element 14, and more preferably, a plurality of SMA wires 14. In FIG. 10a, the slider 52 is recessed within the base 12a, such that the coupling 54 is caused to hang and the base 12a defines the first length. When at least a portion of the wires 14 are activated, the slider 52 is caused to translate towards the fixed coupling 54. As shown in FIG. 10b, this causes the slider 52 to support at least a portion of the flexible segment 50, and the segment 50 to consequently straighten and present the second length.

As is the case in each of the embodiments, a return mechanism 56 is preferably provided to produce a biasing force that works antagonistically to the actuator 16. In this configuration, an exemplary return 56 may be an extension spring connected to the slider 52 (FIGS. 10a,b). The spring 56 presents sufficient modulus to cause the slider 52 to retract within the base 12a upon the deactivation of the wire 14. That is to say, the return 56 produces a biasing force less than the actuation force, so as to cause the base 12a to selectively achieve the first length. In the plural embodiments, the return mechanism 56 may variously present a spring, dead weight, pneumatic or gas spring, or an additional active material element, such as a second SMA wire. In the pivot embodiment of FIGS. 1 and 2, for example, a second SMA wire may be provided for both directions of movement; moreover, with respect to the pinion 46, a torsion, coil, or clock spring also concentrically aligned with the axle may be used to return the free section 40.

The preferred actuator 16 further includes an overload protector 58 configured to present a secondary work output path, when the actuator element 14 is exposed to the signal, and the base 12a is unable to be reconfigured. In FIG. 4, for example, the overload protector 58 is presented by an extension spring 60 connected in series to the element 14 and fixedly to one of the tracks 42. The spring 60 is stretched to a point where its applied preload corresponds to the load level where it is appreciated that the element 14 would begin to experience excessive force if blocked. As a result, activation of the element 14 will first apply a force trying to manipulate the structure 18, but if the force level exceeds the preload in the spring 60 (e.g., base extension is blocked), the wire 14 will instead further stretch the spring 60, thereby preserving the integrity of the actuator 16. Alternative protectors 58 may also be employed; for example, it is appreciated that the distal coupling 54 may be detachable from the segment 50 when a break way force equal to the preferred overload limit is generated thereupon.

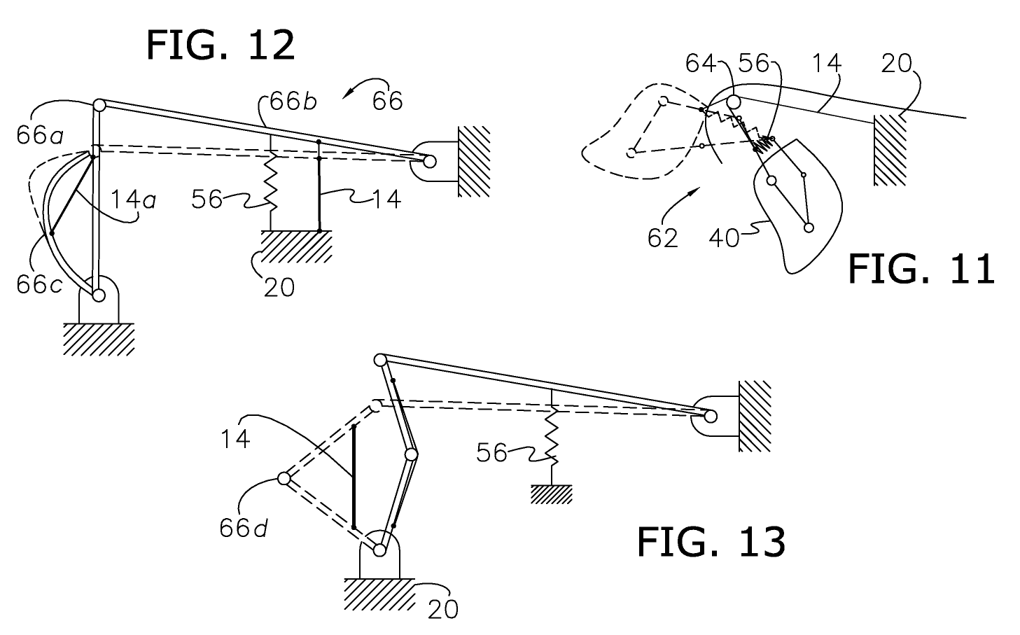

In yet another embodiment, the moveable or free section 40 is caused to translate and rotate to the extended position. As shown in FIG. 11, for example, the structure 18 may be replaced by a four-bar linkage assembly 62. Similar to those employed by self-storing recliner base extensions, the assembly 62 interconnects the fixed and free base sections 38,40 at dual pivot points. The actuator 16 consists of an SMA wire 14 interconnecting a top surface of the assembly 62 and the base frame 20. The wire 14 is entrained above the assembly 62 by a pulley 64 that redirects the wire 14 longitudinally along the base 12a. The pulley 64 is fore the wire-assembly connection point, so that when the wire 14 is activated and caused to contract, the free section 40 is caused to swing outward and upward, as shown in hidden-line type in FIG. 11. A bi-stable mechanism (not shown) may be used to lock the section 40 in either the retracted or extended position; or more preferably, a locking mechanism (also not shown) as previously described may be used to effect multiple stop positions. Finally, an extension return spring 56 is configured to store energy by stretching when the section 40 is in the extended condition. Upon deactivation, the spring 56 releases its energy by driving the assembly 62 and section 40 back towards the recessed condition.

In a final embodiment, the work done by the actuator 16 is augmented by the resting load (weight) of the occupant. For example, and as shown in FIGS. 12 and 13, the base 12a may include a resistively flexible member 66 (e.g., a plastic panel, wire frame, basket or mesh, etc.) that lateral spans the base 12a. The member 66 presents a first raised configuration that defines the first length, when an occupant or object is not reposed on the seat 12. Here, the actuator 16 is drivenly coupled to the member 66 and operable to cause the member 66 to achieve a second position wherein a portion of the member 66 is bowed outward, and positioned so as to be further bowed by the weight of the occupant to a third position that defines the second length. A hard stop (not shown) is preferably presented so that in the third position the base 12a presents a horizontal engagement surface as shown.

More particularly, in this configuration, the member 66 is vertically and horizontally connected to base frame 20, so as to define an “L” shaped structure and a pivotal joint 66a. As shown, in FIG. 12, a vertically oriented SMA wire 14 may interconnect the rigid horizontal component 66b of the member 66 to the base frame 20. In the raised position, the joint 66a is raised so as to present a vertical component 66c of the member 66. When the actuator 16 is activated, the joint 66a is pulled downward, resulting in the bowing of the vertical component 66c. It is appreciated that the weight of the occupant, when present, causes the joint 66a to further lower and the vertical component 66c to further bow, resulting in the second support length.

More preferably, a second auxiliary wire 14a may be provided, and preferably interconnected from the joint 66a to an intermediate point along the height of the vertical component 66c, so as to form a diagonal chord, when the vertical component 66c is bowed (FIG. 12). When the auxiliary wire 14a is activated, the vertical component 66c is caused to further extend the second support length. Finally, a return mechanism 56, such as a vertically oriented compression spring (also shown in FIG. 12) may be provided to bias the member 66 towards the raised configuration; moreover, it is appreciated that the bowed component 66c provides some spring action.

Alternatively, and as shown in FIG. 13, the vertical component 66c may define a second joint 66d that pivotally interconnects upper and lower component sections, so as to form a hinge. Here, the actuator 16 consists of an SMA wire 14 interconnecting the sections and straddling the hinge. Upon activation, the wire 14 contracts causing the joint 66d to be pushed outward and the upper joint 66a to swing downward. The momentum of the second joint 66d pushes it past the vertical plane of the upper joint 66a, causing the vertical component 66c to swing towards the extended position shown in hidden-line type in FIG. 13.

In operation, a signal source 68 is communicatively coupled to the element 14 and operable to generate the activation signal, so as to activate the element 14. For example, in an automotive setting, the source 68 may consist of the charging system of a vehicle, including the battery (FIG. 1), and the element 14 may be interconnected thereto via bus, leads 70, or suitable short-range wireless communication (e.g., RF, bluetooth, infrared, etc.). A button or otherwise input device 72 with an electrical interface to the shape memory alloy element 14 is preferably used to close the circuit between the source 68 and element 14 so as to provide on-demand control of the system 10. It is appreciated that the input device 72 may generate only a request for actuation that is otherwise processed by a gate in the system 10, which determines whether to grant the request. In FIG. 6, the input device 72 is connected to the front of base 12a; whereas in FIG. 1, the input 72 is located on the side of the base 12a so as to present a stationary position less subject to accidental actuation.

Alternatively, the input device 72 may be replaced or supplemented by a controller 74 and at least one sensor 76 communicatively coupled to the controller 74. The controller 74 and sensor(s) 76 are cooperatively configured to cause actuation only when a pre-determined condition is detected (FIG. 1). In an automotive setting, for example, a sensor 76 may be employed that indicates when the vehicle door adjacent to the seating position is open; and the controller 74 may cause the system 10 to retract only when such an ingress or egress event is indicated. As a second example, at least one load cell sensor 76 may be utilized in association with the seat base 12a. In this configuration, the load cell 76 is operably positioned, so as to be able to detect a minimum force (e.g., the weight of an average adult occupant, etc.) placed thereupon. The base 12a may be autonomously extended upon application of the force. In a third example, the sensor 76 is operable to detect the non-presence of an object in front of the base 12a prior to extension. The first and second examples may be combined, wherein the base 12a is retracted upon ingress and egress, and retained in the retracted condition until an occupant or object of sufficient weight is detected. Finally, it is appreciated that where the input device 72 is communicatively coupled to the controller 74, and the controller 74 has stored thereupon a plurality of memory recall lengths, the device 72 and controller 74 may be cooperatively configured to cause the system 10 to achieve a second length, wherein the second length is a selected one of the recall lengths.

It is appreciated that suitable algorithms, processing capability, and sensor inputs are well within the skill of those in the art in view of this disclosure. Again, it is also appreciated that alternative configurations and active material selections are encompassed by this disclosure. For instance, SMP may be utilized to release stored energy, where caused to achieve its lower modulus state.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

What is claimed is:

1. A seat base extension system comprising:
a reconfigurable seat base presenting a first support length;
an actuator drivenly coupled to the base and including an active material element operable to undergo a reversible change when exposed to or occluded from an activation signal; and
a signal source operable to generate and deliver the signal to the element, so as to expose the element to the signal,
said actuator being configured to cause or enable the base to be reconfigured, so as to present a second support length different than the first, as a result of the change.

2. The system as claimed in claim 1, wherein the element is comprised of material selected from the group consisting essentially of shape memory alloys, ferromagnetic shape memory alloys, shape memory polymers, magnetorheological elastomers, electrorheological elastomers, electroactive polymers, and piezoelectric ceramic.

3. The system as claimed in claim 1, wherein the actuator further includes a stored energy element intermediately coupled to the active material element and base, and wherein the stored energy element is operable to release stored energy and cause the base to reconfigure, as a result of the change.

4. The system as claimed in claim 1, wherein the base includes a locking mechanism operable to achieve engaged and disengaged conditions relative to the base, the base is reconfigurable only when the mechanism is in the disengaged condition, the actuator is drivenly coupled to the mechanism and operable to cause the mechanism to achieve the engaged or disengaged condition.

5. The system as claimed in claim 4, wherein the mechanism includes a toothed bar and a moveable pin configured to selectively catch the bar in the engaged condition, and the actuator is drivenly coupled to the pin, so as to cause the pin to disengage the bar as a result of the change.

6. The system as claimed in claim 4, wherein the actuator further includes a bias spring engaging, so as to drive, the mechanism towards the engaged condition.

7. The system as claimed in claim 1, wherein an input device is connected to the base, communicatively coupled to the actuator, and operable to selectively cause the element to change.

8. The system as claimed in claim 1, wherein the base includes a pivotal structure configured to cause the base to achieve a first length when in a first position and a second length when swung to a second position, and the element is a shape memory alloy wire drivenly coupled to the structure and configured to cause the structure to swing as a result of the change.

9. The system as claimed in claim 1, wherein the base presents first and second longitudinally separated sections that cooperatively present the first length, and the actuator is configured to selectively modify the spacing or relative positioning between the sections, so as to define the second length.

10. The system as claimed in claim 9, wherein the sections are coupled by a transmission comprising a rack and pinion, mechanical linkage, nut and screw drive, a gear drive, or a hydraulic or pneumatic coupling, and the actuator is drivenly coupled to, such that the change causes relative displacement in, the rack or pinion.

11. The system as claimed in claim 1, wherein the base includes an outer layer having a faceted distal segment, the segment is pliable, presents a normally distended and non-linear condition that defines the first length, and the element is an SMA wire connected to the segment and configured to cause the segment to straighten, so as to define the second length as a result of the change.

12. The system as claimed in claim 1, wherein the base includes a flexible distal segment defining an internal space, and the actuator includes a slider and a distal coupling disposed within the space, so as to define the first length, and the element interconnects the coupling and slider, such that the slider is caused to translate towards the coupling so as to modify the geometry of the flexible segment and present the second length, as a result of the change.

13. The system as claimed in claim 1, further comprising
a return mechanism drivenly coupled to the base antagonistically to the actuator, and producing a biasing force less than the actuation force, such that the mechanism causes the base to selectively achieve the first length.

14. The system as claimed in claim 13, wherein the return mechanism is selected from the group consisting essentially of compression, extension, leaf, and torsion springs, dead weights, pneumatic and gas springs, and additional active material elements.

15. The system as claimed in claim 1, wherein the actuator further includes an overload protector in series connection to the element, and configured to present a secondary work output path, when the element is exposed to the signal, and the base is unable to be reconfigured.

16. The system as claim in claim 1, wherein the base includes a flexible member presenting a first raised position that defines the first length, the actuator is drivenly coupled to the member and operable to cause the member to achieve a second position wherein the member is bowed outward, and the member is configured so as to be further bowed by the weight of an occupant to a third position that defines the second length.

17. A seat base extension system comprising:
a reconfigurable seat base operable to alternatively present first and second support lengths;
a locking mechanism including an active material element operable to undergo a reversible change when exposed to or occluded from an activation signal, and configured to engage the base, so as to retain the base in one of the first and second support lengths, and selectively disengage the base, so as to enable the base to achieve the other of said first and second lengths; and
a signal source operable to generate and deliver the signal to the element, so as to expose the element to the signal.

18. A seat base extension system comprising:
a reconfigurable seat base presenting a first support length;
an actuator drivenly coupled to the base, including an active material element operable to undergo a reversible change when exposed to or occluded from an activation signal, and configured to cause or enable the base to reconfigure, so as to present a second support length different than the first, as a result of the change;
a signal source operable to generate and deliver the signal to the element, so as to expose the element to the signal;
a controller communicatively coupled to the actuator; and
a sensor communicatively coupled to the controller and operable to detect a condition,
said controller and sensor being cooperatively configured to autonomously cause the element to undergo the change, only when the condition is detected.

19. The system as claimed in claim 18, wherein the condition is an ingress or egress event, a load placed upon the base, or the non-presence of an object in front of the base.

20. The system as claimed in claim 18, further comprising an input device communicatively coupled to the controller, wherein the controller has stored thereupon a plurality of memory recall lengths, the device and controller are cooperatively configured to cause the actuator to cause the base to achieve the second length, and the second length is a selected one of the recall lengths.
